(19) United States
(12) Patent Application Publication
(10) Pub. No.: US 2009/0158443 A1
(43) Pub. Date: Jun. 18, 2009

(54) PIRACY PREVENTION, DETECTION, AND CONTENT MANAGEMENT

(75) Inventors: Francisco A. Dias, Krum, TX (US); Paul V. Hubner, McKinney, TX (US); Steven T. Archer, Dallas, TX (US); Kristopher A. Pate, Sachse, TX (US)

Correspondence Address: VERIZON;PATENT MANAGEMENT GROUP, 1320 North Court House Road, 9th Floor, ARLINGTON, VA, 22201-2909, US

(73) Assignees: Verizon Business Network Services Inc., Ashburn, VA (US); MCI Communications Services, Inc., Ashburn, VA (US)

(21) Appl. No.: 11/957,738

(22) Filed: Dec. 17, 2007

(51) Int. Cl. G06F 21/00

(52) U.S. Cl. 726/32

(57) ABSTRACT

A computing device is configured to receive media content and determine if the received media content includes a stego message. If the media content includes a stego message, then the computing device is further configured to decode at least a portion of the stego message, and perform a task based in part on the decoded portion of the stego message.

### BACKGROUND INFORMATION

Copyright piracy has become an issue for various copyright holders. Such copyright holders wish to curb piracy, which includes illegal reproductions of movies, sound recordings, concerts, sporting events, and other copyright-protected material. While digital rights management (DRM) software and encrypted digital video discs (DVDs) help, copyright holders are looking for additional and potentially more powerful mechanisms to prevent and detect certain forms of piracy. For example, pirated copies of movies and sound recordings are often created by movie theatre patrons with video cameras. Unfortunately, copyright holders are often unable to prevent such recordings, or track when/where such recordings took place.

While copyright holders desire additional piracy prevention and detection tools, they also desire ways to enhance their material. For example, new or emerging artists may want to share their works, such as by helping a consumer share a song or an album with friends. In addition, artists are often looking for new ways to enhance live performances, such as concerts and sporting events, by providing additional interactive features to an audience.

### BRIEF DESCRIPTION OF THE DRAWINGS

FIG. 1 illustrates an exemplary system for embedding, managing, and using a steganographic message.

FIG. 2 illustrates an exemplary process for creating a steganographic message.

FIG. 3 illustrates an exemplary process for handling a steganographic message.

### DETAILED DESCRIPTION OF PREFERRED EMBODIMENTS

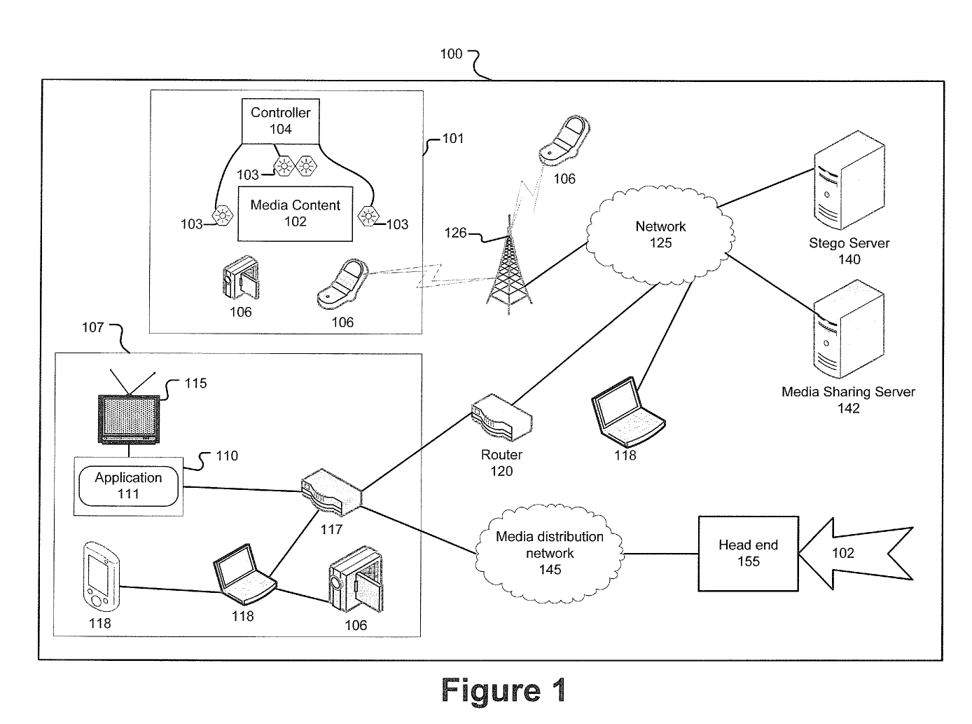

FIG. 1 illustrates an exemplary system 100 for adding, combining, embedding, managing, and using a steganographic (stego) message. A stego message may be embedded into a recording of media content 102 at a venue 101. Media content 102 is typically an audio, visual, or audio-visual work, and may be live or previously recorded. For example, media content 102 may be a song, a movie, a concert performance, a sporting event, or the like. Media content 102 also commonly includes copyright-protected material, and is often displayed or performed at a venue 101. Venue 101 is typically a location where media content 102 can be perceived by a person. Venue 101 may be a movie theatre, a sporting arena, a stadium, a concert venue, a recording studio, a movie set, or some other location. A person at a venue 101 may have a recording device 106 that is capable of recording media content 102.

Many copyright holders and venue operators prohibit making unauthorized recordings of media content 102 at certain events, including at various venues 101. Unfortunately, a person may nevertheless sneak a recording device 106 into venue 101 in order to record media content 102, and thereby make an unauthorized copy or reproduction of media content 102. Recording device 106 may be any device capable of recording audio and/or video. Recording device 106 may be a hand-held video camera, a camcorder, a cellular phone, or the like. For example, a person may sneak a video camera into a movie theatre to make an unauthorized copy of a movie. A stego message may be used to prevent, detect, and track such unauthorized reproductions.

On the other hand, there are other occasions where audience members are encouraged to record media content 102, and possibly to share those recordings with others. For example, a new band may want to share their music, and may suggest or encourage audience members at a concert to use recording device 106 to record their music. In addition, concert promoters may desire to provide additional interactive services to audience members at a concert. An embedded stego message may provide audience members with additional interactive services, information, features, and may facilitate sharing recorded media content 102. Further, a media content provider may use a stego message to prohibit unauthorized reproductions of media content 102, include copyright information, include additional information about the media content, provide interactive features, etc.

A stego message may also be referred to as a digital watermark, or an invisible watermark. A stego message can be used for a wide variety of purposes, including for combating copyright piracy. For example, a stego message may be used to prevent, detect, or trace the origins of unauthorized reproductions of copyright-protected material. Further, a stego message may be used to provide additional information accompanying media content 102. In addition, a stego message may be used by one or more computing devices to perform a task, as will be discussed in greater detail below.

Generally, a stego message is data that can be embedded into media content 102, without significantly degrading the audio or visual quality of media content 102. A stego message typically uses a signal that is difficult to detect by a person perceiving the media content 102. A stego message may include a wide variety of information, including a copyright notice, a copyright holder name, a copyright licenses type, a recording flag, a time, a date, a location, a production number, a code, a song lyric, closed captioned information, a dialog text, a trivia fact, or some other information, including a computer-readable instruction. Typically, a stego message is encoded using any number of different encoding systems, including proprietary or cryptographic encoding schemes. System 100 is one example of a system for embedding a stego message into a recording of media content 102, and generally includes an emitter 103 and a controller 104.

Emitter 103 generally provides a signal that is not easily detectable by a person, but will be recorded by recording device 106. For example, many video cameras can capture infrared (IR) light, which is invisible to the human eye. Emitter 103 may be an IR light emitter, such as a light emitting diode (LED), a cluster of IR light emitters, such as an LED array, or any other light source capable of producing infrared light, such as a light bulb or flashlight with an infrared filter. Emitter 103 is typically positioned to ensure that any recording device 106 that attempts to record media content 102 also records the IR light provided by emitter 103. As shown in FIG. 1, several emitters 103 are positioned adjacent to and behind media content 102 to ensure that a recording device 106 aimed at media content 102 also records an IR signal from emitters 103. In some circumstances, emitter 103 may be used to prevent unauthorized recordings of media content 102. For example, some recording devices 106 may be susceptible to IR white-washing, where a recorded video image is degraded due to intense IR light. System 100 may prevent unauthorized recordings in venue 101 by using an IR emitter 103 to provide constant high-intensity IR light, thereby flooding or white-washing the video portion of an audio-visual recording made by recording device 106.

Emitter 103 may also be a speaker or device that provides an acoustic signal. For example, many audio recording devices can record sound waves that a person cannot hear or detect. Such sound waves may be high, or low frequency sound waves that are not perceivable by the human ear. Alternatively, emitter 103 may provide an acoustic signal that is perceivable to a human, but is not easily detectable or noticeable when mixed with media content 102. For example, emitter 103 may provide a quiet or low-decibel acoustic signal that can blend in to the background noise of a rock concert, or a loud acoustic signal that mimics audience noise at certain events, such as concerts or sporting events. Emitter 103 may be a transducer, a radio frequency (RF) generator, or any other device capable of producing ultra high frequency, high frequency, low frequency, and/or ultra low frequency acoustic signals, whether or not such signals are perceivable by a person.

Emitter 103 is typically operated by use of a controller 104. Controller 104 generally operates emitter 103 by sending control signals. For example, controller 104 may turn emitter 103 on and off to create pulses that can include encoded information or a stego message. Controller 104 may be a computing device capable of executing instructions stored on a computer readable medium, and may include a processor and a memory. Although shown in FIG. 1 as a separate device, controller 104 may be integrated with emitter 103. Further, system 100 may use multiple controllers 104, and such controllers 104 may communicate with one another, or with another computing device using wired or wireless communication systems. Further, controller 104 may utilize more than one type of emitter 103, potentially creating a stego message that includes both an audio and a video portion. Generally, emitter 103 can be any device capable of producing signals that can be received by a recording device 106.

Recording device 106 may be a hand-held video camera, a camcorder, a cellular phone, a digital audio recorder, or the like. For example, cellular phones often include audio and/or video recording capabilities. In addition, recording device 106 may be any professional-grade recording device or system used to record audio and/or video, including equipment used in recording studios and movie sets. Recording device 106 may also include a processor and a memory for processing computer-readable instructions. In addition, a recording device 106 may include hardware and software for communicating over one or more networks, including a cellular network 126 and a packet-switched network 125. Further, recording device 106 may include hardware and/or software for receiving, interpreting, and processing a stego message, including performing a task based on a stego message.

System 100 may also include various devices and networks for transferring, recording, and perceiving media content 102. System 100 may also include a customer premise 107, a content processing device 110, a computing device 118, and one or more networks 125, 145. Customer premises 107 may be a home, business, or any other location including content processing device 110, and may include multiple content processing devices 110.

Content processing device 110 generally is a specialized device, e.g., a set top box (STB) or similar device, for receiving media content 102 from head end 155 via a network 145, and for providing media content 102 to a media player 115. Media content 102 may be provided as an analog signal, or as a digital signal, e.g., an analog or digital video signal including a media stream. Further, media content 102 may include an embedded stego message. Content processing device 110 generally includes a processor and a memory, and may be provided with a proprietary or specialized operating system. For example, content processing device 110 may be an STB provided with a real time operating system (RTOS) such as is known. However, it is to be understood that the role generally ascribed to content processing device 110 herein may be filled by a computing device such as computing device 118, a recording device 106, a mobile device such as a cellular telephone, so long as the device is capable of receiving media content 102 from network 145 and/or through network 125, and is capable of storing and executing such program instructions as may be stored on a computer-readable medium. Further, such a computing device need not be located within customer premises 107, but generally may be located anywhere that it may access a packet switched network 125.

Media player 115 receives media content 102 from content processing device 110, and plays such media content 102 so that it can be perceived by a user. Media player 115 may be a television receiver, such as is known, including a television or a high definition television (HDTV). Media player 115 may also be used to provide a user interface to certain functions and menus provided by content processing device 110. For example, a television may be used to display a graphical user interface to access various menus within a STB. Further, it is possible and in many cases likely that operations ascribed herein to content processing device 110 and media player 115 may all or mostly be performed by a computing device, such as computing device 118 or the like, whereby media player 115 and/or content processing device 110 may be omitted from system 200. Media player 115 may also include a processor and a memory, and may be provided with a proprietary or specialized operating system. For example, media player 115, as well as computing device 118, may include a processor, a memory, and program instructions for identifying and processing a stego message, including instructions for performing a task based on a stego message.

Computing device 118 may be any device capable of processing a stego message in media content 102. For example, computing device 118 may be a computer workstation, a desktop, a notebook computer, a laptop, a handheld computer, a personal digital assistant (PDA), a cellular phone, a smart-phone, an MP3 player, a digital video disk (DVD) player, a video cassette player, or some other computing or media device that includes a processor, a memory, and program instructions for processing a stego message. Further, computing device 118 may also include program instructions for performing a task based on a stego message.

Content processing device 110 selectively communicates with various devices via a broadband home router (BHR) 117, including computing device 118. BHR 117 may be one or more devices that are generally known for routing network traffic. BHR 117 facilitates data transfer over one or more networks, including a packet switched network 125 and a media distribution network 145.

BHR 117 is known for distributing audio, video, and data to devices within customer premises 107 such as content processing device 110. For example, BHR 117 may be a broadband home router or wireless broadband home router from Actiontec Electronics, Inc. of Sunnyvale, Calif. BHR 117 may also provide a wired or wireless local area network (LAN), thereby providing selective communications between various devices within customer premises 107. For example, computing device 118 may utilize BHR 117 to communicate with content processing device 110. Computing device 118 may be a computer workstation, a desktop, notebook, laptop, handheld computer, a personal digital assistant (PDA), a cellular phone, a smart-phone, or some other computing device utilizing hardware and software to communicate with content processing device 110.

Content processing device 110 may use BHR 117 to send information to, and receive information from, a packet switched network 125. BHR 117 may access packet switched network 125 through a gateway router 120. Content processing device 110 may also receive, via a packet switched network 125, media content 102 from one or more devices, including recording device 106, such as a cellular telephone.

A media distribution network 145 is a network for providing media content 102, such as is known. For example, network 145 may include hardware and software for providing a video signal via a coaxial cable and/or a fiber optic cable. As is known, media content 102 is generally provided to a media distribution network 145 from a head end 155.

Packet switched network 125 is generally an internet protocol (IP) network that utilizes known protocols found generally within the internet protocol suite. For example, network 125 uses protocols such as user datagram protocol (UDP), transmission control protocol (TCP), hypertext transfer protocol (HTTP), etc. Further, network 125 may include a variety of networks such as a wide area network (WAN), e.g., the Internet, a local area network (LAN), a fiber-optic network, a cellular network 126, etc. For example, network 125 may include a wireless cellular network 126 for communicating with various wireless devices, including a cellular telephone, a personal digital assistant (PDA), a smart phone, recording device 106, computing device 118, etc. As is known, packet switched network 125 may be used to transport a variety of data, including multimedia data, such as audio and video. Accordingly, it is to be understood that exemplary implementations are possible in which networks 125 and 145 are in fact combined into a single network, or in which media distribution network 145 is simply omitted, whereby packet switched network 125 is used to provide media content 102 to content processing device 110, computing device 118, etc.

Gateway router 120 is known for routing data packets in packet switched network 125. Gateway router 120 allows content processing device 110 to access packet switched network 125. By communicating with router 120, content processing device 110 is able to obtain a network address such as an internet protocol (IP) address, thereby enabling content processing device 110 to make requests to, and to receive data from one or more devices, such as a recording device 106, computing device 118, stego server 140, media sharing server 142, or the like.

Stego server 140 is generally a computing device capable of performing various functions, including encoding a stego message, embedding a stego message in media content 102, receiving media content 102, identifying a stego message in media content 102, decoding a stego message, and performing one or more tasks based on a stego message. For example, stego server 140 may receive media content from a device via network 125, embed a stego message into the received media content, and provide the media content 102 to another device via network 125. Further, stego server 140 may include hardware and/or software for searching one or more websites for potential copyright violations. For example, stego server 140 may include a search engine for searching websites, including one or more media sharing websites, to find media content 102, and further analyze such media content 102 for a particular stego message to identify a potential copyright violation.

Media sharing server 142 is generally a computing device that provides a media content sharing service, such as a media sharing website. Media sharing server 142 may send and receive media content 102 with one or more devices, such as recording device 106, content processing device 110, computing device 118, and the like. Further, media sharing server 142 may also perform various functions relating to a stego message, including encoding a stego message, embedding a stego message in media content 102, identifying a stego message in media content 102, decoding a stego message, and performing one or more tasks based on a stego message.

Media content 102 may be provided from one or more devices in system 100, typically via media distribution network 145, packet-switched network 125, or the like. Further, media content 102 may be provided by a device connected to one or more networks, including recording device 106. For example, as shown in FIG. 1, recording device 106 may be a cellular telephone capable of communicating over network 125, or recording device 106 may be a video camera connected to computing device 118, which is also connected to network 125. Media content 102 may include an embedded stego message, or a stego message may be embedded by a computing or networking device before, during, or after being transferred from one device to another. For example, media content 102 may be transferred from recording device 106 to computing device 118. Computing device 118 may include hardware and/or software for embedding a stego message into media content 102. Further, media content 102 may be transferred between two recording devices 106, such as between two cellular telephones via network 125. In such an example, either cellular telephone, or network 125, 126 may embed a stego message in media content 102 before, during, or after the media content has been transferred.

Content processing device 110, recording device 106, computing device 118, as well as any other device capable of executing program instructions may include an application 111. Application 111 generally includes program instructions in a computer readable medium for, among other things, encoding a stego message, embedding a stego message in media content 102, identifying a stego message in media content 102, decoding a stego message, and performing one or more tasks based on a stego message, as will be discussed in more detail below.

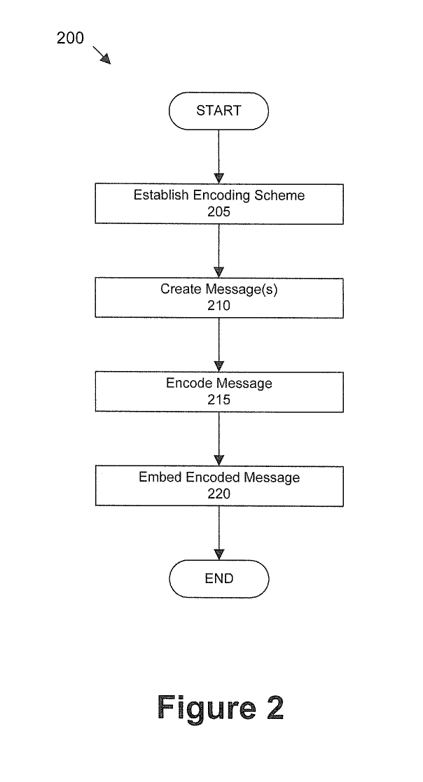

FIG. 2 illustrates an exemplary process 200 for creating a stego message. One or more steps of process 200 may be performed by application 111, and may be performed by any computing device, including recording device 106, in system 100.

Process 200 begins in step 205 by establishing an encoding scheme. Generally, a stego message, as described above, is comprised of audio and/or visual pulses, possibly produced by emitter 103. An encoding scheme may be as simple as Morse code, or may employ one or more cryptographic elements. Further, an encoding scheme may simply be a simple code to represent one or more pieces of information, such as a time, a date, a copyright notice, an instruction, etc. In one example, an encoding scheme may be adopted by a consortium of consumer electronic manufacturers, media content creators, copyright holders, media content providers, and the like, such that a stego message may be used by many devices in system 100. An encoding scheme may also be adopted privately by one copyright holder and kept secret, such that the copyright holder may be able to identify pirated content.

Next, in step 210, a message is created. A message may be a simple copyright notice, or may a complex set of instructions. Further, a message may include additional information for a user. For example, a user at a concert may be able to use a recording device 106, such as a cellular phone, to receive music lyrics via a stego message.

Next, in step 215, the message is encoded using the selected encoding scheme. Generally, a computing device, such as controller 104, computing device 118, stego server 140, or the like will encode the message. For example, a professional videographer may desire to include an embedded stego message in a recently recorded video. As such, the videographer may use computing device 118 to create and encode a message to be embedded in the video.

Next, in step 220, the encoded message is embedded in media content 102. The encoded message may be embedded using emitter 103 and controller 104, or the encoded message may be embedded using application 111 on a computing device. For example, the encoded message may be embed by including a series of IR pulses in media content 102 by using either an analog or a digital system.

Following process 200, media content 102 includes an encoded message, i.e. a stego message, which is difficult for a person to perceive, but identifiable by a computing device.

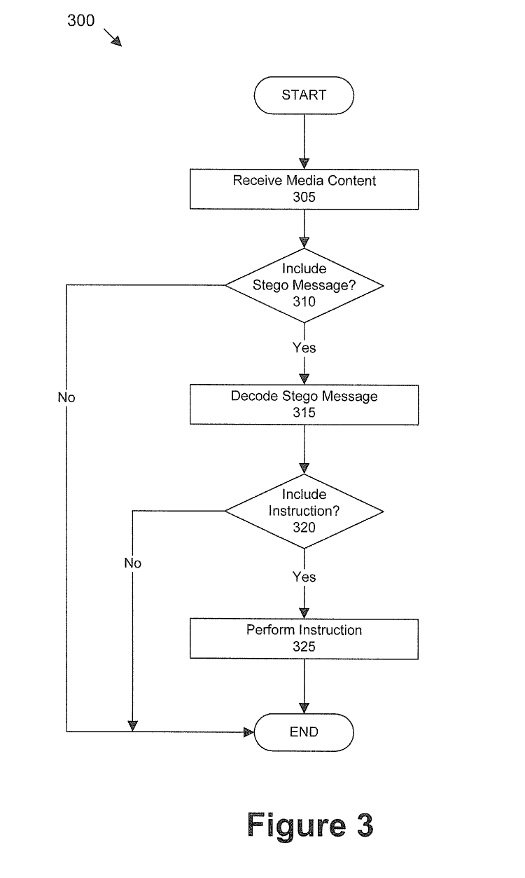

FIG. 3 illustrates an exemplary process 300 for handling or processing a stego message. One or more steps of process 300 may be carried out by application 111 on one or more devices in system 100, including recording device 106, content processing device 110, media player 115, computing device 118, stego server 140, media sharing server 142, and the like.

Process 300 begins in step 305 when media content 102 is received. Media content 102 may be received via any analog or digital system, or may be received from a live performance. For example, recording device 106, such as a video camera or a cellular telephone, may receive media content 102 by recording a live performance. Further, devices such as content processing device 110, computing device 118, and the like may receive media content 102 via network 125.

Next in step 310, the received media content is checked for a stego message. Generally, a computing device, such as recording device 106, content processing device 110, etc. may continually monitor for indicators that a stego message is included in the received media content 102. For example, such devices may monitor for a specific sequence of IR pulses or audio cues. If media content 102 does not include a stego message, then process 300 ends. If media content 102 includes a stego message, then process 300 proceeds to step 315.

In step 315, the stego message is decoded. The stego message may be decoded using a standard encoding scheme, as established by a consortium, or the stego message may include an encoding scheme identifier. For example, the beginning of each message may include an identifier indicating which encoding scheme was used to encode the message.

Next, in step 320, the decoded message is checked for an instruction. A stego message may include a direct instruction or an indirect instruction. Generally, a direct instruction provides a specific task to perform, such as to stop recording, alert a copyright holder, or to copy the media content to another device, such as media sharing server 142. The stego message may also include an indirect instruction, such as one or more pieces of information that may be interpreted as an instruction. For example, a stego message may include a “no record” flag, informing a recording device that the received media content should not be recorded. Further, the stego message may include a copyright holder's name. A device receiving media content 102 may interpret that information as an indirect instruction, directing the device to include a copyright notice and the copyright holder's name on a recording of the media content. If the stego message doesn't include any direct or indirect instruction, then process 300 ends. If the stego message includes at least one direct or indirect instruction, then process 300 proceeds to step 325.

In step 325, the receiving device performs the requested instruction. For example, any device capable of processing a stego message may perform one or more tasks based on the stego message. Such devices include recording device 106, content processing device 110, computing device 118, stego server 140, and media sharing server 142. For example, a video camera or a cellular phone may respond to a stego message by terminating a recording session, displaying a message, sending a message to a remote device, contacting a copyright holder, copying the recorded media content 102 to media sharing server 142, etc. In addition, a device may segment the received media content 102 based on a received stego message. For example, a band playing at a concert may use a stego message to signal the end of one song and the beginning of another, and may also include additional information, such as the date, time, location, venue 101, song title, etc. Recording device 106, such as a video camera or a cellular phone, may respond to the stego message by creating breaks between each song. In addition, various computing devices 118, such as a digital music player or a portable media player, may recognize an embedded stego message in media content 102, thereby allowing a user to select an individual song among many in one recording.

Stego server 140 may perform any number of tasks based on a stego message. For example, stego server 140 may conduct periodic Internet web searches for media content 102, and check such media content 102 for a stego message. Based on a stego message, stego server 140 may contact a copyright holder, an Internet service provider, a host of a website, a user, etc. in order to inform the recipient of a possible copyright violation. Further, a stego message may include a recording date, time, and place, and stego server 140 may maintain a log of various pirated copies of media content 102. For example, a stego message may identify a particular movie theatre along with a time and date. Stego server 142 may create a log entry detailing that an unauthorized reproduction was made at that particular movie theatre, or stego server 142 may inform a copyright holder to remove that movie theatre from a list of theatres to receive media content 102 in the future. Stego server 140 may also work in conjunction with other devices and websites, including media sharing server 142. For example, media sharing server 142 may forward an encoded stego message to stego server 140. Stego server 140 may then decode the stego message, and perform a task, such as informing the sender of the stego message that the media content 102 containing that stego message is an unauthorized reproduction.

In another example, content processing device 110 may perform any number of tasks based on a stego message. For example, content processing device 110 may prohibit a user from perceiving media content 102 that includes a particular copyright notice, a “no record” flag, or some other indication that media content 102 is an unauthorized reproduction. Further, content processing device 110 may download additional information for a user based on a stego message in media content 110. For example, content processing device 110 may decode a stego message containing information about media content 102, such as the title, artist, genre, etc. Content processing device 110 may then obtain additional information specific to media content 102, such as music lyrics, fun facts, or even additional media content 102 from the same artists, genre, album, etc.

Computing devices such as recording device 106, content processing device 110, computing device 118, stego server 140, media sharing server 142, and similar devices may employ any of a number of known computer operating systems. For example, such devices may use any known versions and/or varieties of the Microsoft Windows operating system; the Unix operating system (e.g., the Solaris operating system distributed by Sun Microsystems of Menlo Park, Calif.); the AIX UNIX operating system distributed by International Business Machines of Armonk, N.Y.; and the Linux operating system and the Vortex operating system distributed by Motorola, Inc. of Schaumberg, Ill. Computing devices may include any one of a number of computing devices that are known, including, without limitation, a computer workstation, a desktop, notebook, laptop, handheld computer, STB, or some other computing device.

Computing devices, such as content processing device 110 and other devices mentioned herein, generally are capable of executing instructions stored on a computer readable medium, such as instructions included in application 111. Computer-executable instructions may be compiled or interpreted from computer programs created using a variety of known programming languages and/or technologies, including, without limitation, and either alone or in combination, Java, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computing device. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

We claim:

1. A method, comprising:
receiving a media content in a computing device;
determining if the media content includes a stego message;
if the media content includes a stego message, then decoding at least a portion of the stego message; and
performing a task based in part on the decoded portion of the stego message.

2. The method of claim 1, wherein the computing device is at least one of a content processing device, a set-top box, a recording device, a video camera, a camcorder, a cellular phone, a desktop computer, a laptop computer, a server computer, a digital music player, a digital video disc player, a digital video recorder, a personal video recorder, a video game console, a computer, a hand-held video player, a television, a personal digital assistant, a smart phone, and a portable media player.

3. The method of claim 1, wherein the media content is at least one of a streaming media signal, a live performance, a movie, a television show, a sound recording, a song, and a sporting event.

4. The method of claim 1, further comprising denying access to the media content in a content processing device if the stego message includes a copy protection notice.

5. The method of claim 1, further comprising terminating a recording session in a recording device if the stego message includes an instruction to limit recording.

6. The method of claim 1, further comprising embedding the stego message in the media content in a stego server.

7. The method of claim 1, further comprising embedding the stego message in the media content using an infrared emitter at a venue.

8. The method of claim 1, further comprising searching a website for media content that includes a stego message.

9. The method of claim 1, further comprising pulsing infrared light to compose at least a portion of the stego message.

10. The method of claim 1, further comprising embedding an acoustic signal in the media content to compose at least a portion of the stego message.

11. The method of claim 1, further comprising displaying a message in response to the decoded portion of the stego message.

12. The method of claim 1, further comprising notifying a copyright holder via a network upon the stego message indicating that the media content is an unauthorized reproduction.

13. The method of claim 1, further comprising copying the media content to media sharing server based in part on the decoded portion of the stego message.

14. The method of claim 1, further comprising segmenting the media content based on the stego message.

15. A system, comprising:
a content processing device configured to selectively receive a streaming media signal, determine whether the streaming media signal includes a stego message, and provide a copy of the stego message to another computing device; and
a stego server configured to selectively receive a stego message from the content processing device, decode at least a portion of the stego message, and provide an instruction to the content processing device based on the decoded portion of the stego message.

16. The system of claim 15, wherein the content processing device is a set-top-box that is further configured to receive the instruction from the stego server, and perform a task based at least in part on the received instruction.

17. The system of claim 15, further comprising a computing device configured to provide the streaming media signal to the content processing device.

18. The system of claim 15, further comprising a recording device configured to determine whether the streaming media signal includes a stego message, provide a copy of the stego message to the stego server, receive an instruction from the stego server, and selectively performing a task based at least in part on the instruction.

19. The system of claim 15, wherein the content processing device is further configured to receive the instruction from the stego server, and selectively denying access to the streaming media signal based on the instruction.

20. The system of claim 15, wherein the content processing device is further configured to decode at least a portion of the stego message, and perform a task based at least in part on the decoded portion of the stego message.

21. A system, comprising:
an emitter positioned near a source of media content and configured to embed an encoded stego message in the media content;
a controller in communication with the emitter and configured to provide the encoded stego message to the emitter; and
a computing device configured to receive a streaming media signal that includes the encoded stego message, decode at least a portion of the encoded stego message, and perform a task based at least in part on the decoded portion of the stego message.

22. The system of claim 21, wherein the computing device is a set-top-box configured to deny access to the media content if the decoded portion of the stego message indicates that the media content is an unauthorized reproduction.

23. The system of claim 21, wherein the computing device is a recording device configured to terminate a recording session if the decoded portion of the stego message indicates that the media content is copyright protected.

24. The system of claim 21, wherein the emitter provides infrared light and is at least one of a light emitting diode and a light source with an infrared filter.

25. The system of claim 21, wherein the emitter is capable of producing an acoustic signal and is at least one of a speaker, a transducer, and a radio frequency generator.
